(19) United States
(12) Patent Application Publication
(10) Pub. No.: US 2014/0248588 A1
(43) Pub. Date: Sep. 4, 2014

(54) Portable device to control simulated aircraft in air traffic control training system

(71) Applicants: Grant Williams, Bentleigh (AU); Mark James O'Flynn, Balwyn North (AU); Roland Huber, Melbourne (AU); Mark Palmer, Melbourne (AU)

(72) Inventors: Grant Williams, Bentleigh (AU); Mark James O'Flynn, Balwyn North (AU); Roland Huber, Melbourne (AU); Mark Palmer, Melbourne (AU)

(73) Assignee: Thales Australia Limited, Garden Island, New South Wales (AU)

(21) Appl. No.: 14/347,171

(22) PCT Filed: Jun. 5, 2012
(86) PCT No.: PCT/AU2012/000641

§ 371 Date: May 23, 2014

(30) Foreign Application Priority Data
Oct. 4, 2011 (AU) 2011904109

(51) Int. Cl. G09B 9/42

(52) U.S. Cl. CPC G09B 9/42
USPC 434/47

(57) ABSTRACT

A portable electronic device (1410) for controlling a simulated aircraft in a training exercise executing in an Air Traffic Control (ATC) system having a simulator, a method of doing the same using a portable electronic device (1410), and a computer program product are disclosed. The device is capable of wirelessly communicating with the simulator (1420, 1430) also suitable adapted for wireless communications. The device (1410) comprises a display (2014), a memory (2006) for storing data and one or more computer programs, a user input mechanism (2002, 2070, 2071), and a processor (2005). The device (1410) displays on the display information about an aircraft in a training exercise executing on the simulator and receives inputs to control the aircraft in the training exercise on the simulator. The displayed information and the received inputs are communicated between the simulator and the portable electronic device (1410).

### RELATED APPLICATION

The present application claims the benefit, in the U.S. under 35 U.S.C. §119, of the earlier filing date of Australian Provisional Application No. 2011904109 filed on 4 Oct. 2011 in the name of Thales Australia Limited, which is incorporated herein by reference in its entirety.

### TECHNICAL FIELD

The present invention relates generally to the field of Air Traffic Control (ATC) systems and more particularly to training systems and simulators for Air Traffic Control systems.

### BACKGROUND

Current ATC training systems require one or more dedicated, fixed, positions to control the behaviour of simulated aircraft within a training exercise executing on a simulator of an ATC system. Such positions are called pilot positions and are sometimes in a room separate to the ATC trainee.

An ATC training instructor may be required to stand adjacent to or behind a trainee during a training exercise. If the instructor requires that a simulated aircraft performs a particular manoeuvre (e.g. climb, descend, speed change, etc.) or requires information about aircraft in the training exercise, the instructor must communicate with an operator of one of the pilot positions to make the desired change or request the information. This can at times be inconvenient, cause changes to occur too late, and even forewarn the trainee of any unexpected aircraft behaviour that the trainee should be unaware of for the sake of realism in the training exercise.

During execution of an ATC training exercise, an ATC instructor would communicate with the operator of the pilot position verbally. This would usually be done utilising a dedicated channel on a voice switch, which requires that the instructor connect (plugs in) a headset to the voice communications system at one of the ATC trainee positions.

The delay in communicating and getting another operator to perform an action results in a loss of fidelity in the control of the training exercise. Actions are not performed as efficiently as the actions should be.

### SUMMARY

In accordance with an aspect of the invention, there is provided a portable electronic device for controlling a simulated aircraft in a training exercise executing in an Air Traffic Control (ATC) system having a simulator. The device comprises a wireless communications interface, a display, a memory for storing data and one or more computer programs, a user input mechanism for receiving inputs, and a processor. The wireless communications interface enables wireless communications with the simulator, also suitably adapted for wireless communications. The processor is coupled to the memory, the user input mechanism, the display, and the wireless communications interface. The processor executes computer program code for displaying on the display information about an aircraft in a training exercise executing on the simulator and for receiving inputs to control the aircraft in the training exercise on the simulator. The displayed information and the received inputs are communicated between the simulator and the portable electronic device.

Preferably, the portable electronic device is implemented in a tablet computing device, where the display and the user input mechanism are implemented using a touchscreen.

The computer program executing on the processor may provide an Aircraft Control Display displayed on the display.

The portable electronic device may further comprise computer program code executing on the processor to provide graphical objects (e.g., buttons) displayed on the display for controlling operation of an aircraft in the training exercise on the simulator in response to a user input received by the user input mechanism.

The portable electronic device may further comprise computer program code executing on the processor to provide a graphical object (e.g., a button or icon) for displaying and adjusting operating parameters of the aircraft in the training exercise that are carried out on the simulator.

In accordance with another aspect of the invention, there is provided a method of controlling a simulated aircraft in a training exercise executing in an Air Traffic Control (ATC) system having a simulator. The method comprises: displaying on a display of the portable electronic device information about an aircraft in the training exercise executing on the simulator; receiving inputs using the portable electronic device to control the aircraft in the training exercise executing on the simulator; and wirelessly communicating the displayed information and the received inputs between the simulator and the portable electronic device.

The portable electronic device)may comprise a wireless communications interface for wirelessly communicating with the simulator adapted for wireless communications, a memory for storing data and one or more computer programs, a user input mechanism for receiving inputs, and a processor coupled to the memory, the user input mechanism, the display, and the wireless communications interface, the processor executing computer program code for displaying on the display information about the aircraft in the training exercise executing on the simulator and for receiving inputs to control the aircraft in the training exercise on the simulator, the displayed information and the received inputs being communicated between the simulator and the portable electronic device.

Preferably, the portable electronic device comprises a tablet computing device, where the display and the user input mechanism are implemented using a touchscreen.

The method may comprise displaying an Aircraft Control Display on the display.

The method may comprise providing graphical objects displayed on the display for controlling operation of the aircraft in the training exercise on the simulator in response to a user input received by the user input mechanism.

The method may comprise providing a graphical object for displaying and adjusting one or more operating parameters of an the aircraft in the training exercise carried out on the simulator.

In accordance with still another aspect of the invention, there is provided a computer program product comprising a computer readable medium having recorded thereon a computer program for controlling using a portable electronic device a simulated aircraft in a training exercise executing in an Air Traffic Control (ATC) system having a simulator. The computer program comprising: computer program code for displaying on a display of the portable electronic device information about an aircraft in the training exercise executing on the simulator; computer program code for receiving inputs using the portable electronic device to control the aircraft in the training exercise executing on the simulator; and computer program code for wirelessly communicating the displayed information and the received inputs between the simulator and the portable electronic device.

In accordance with yet another aspect of the invention, there is provided a air traffic control (ATC) training system, comprising: a simulator for performing a training exercise involving one or more simulated aircraft, the simulator adapted to receive from a trainee instructions for the training exercise, the simulator comprising a wireless communications interface adapted for wireless communications; and a portable electronic device, as set forth hereinbefore, for controlling a simulated aircraft in the training exercise via wireless communications with the simulator.

These and other aspects of the invention are described in greater detail hereinafter.

### BRIEF DESCRIPTION OF THE DRAWINGS

Embodiments of the invention are described hereinafter with reference to the drawings, in which:

FIG. 1 is a screenshot of an Aircraft Control Display of a portable electronic device for controlling aircraft in a training exercise in an ATC system;

FIG. 2 is an expanded view in isolation of an Exercise Time Panel in the Aircraft Control Display of FIG. 1;

FIG. 3 is an expanded view in isolation of an Active Track List Panel in the Aircraft Control Display of FIG. 1;

FIG. 4 is an expanded view in isolation of a Pilot Track Detail Panel in the Aircraft Control Display of FIG. 1;

FIG. 5 is an expanded view in isolation of a Track Information Panel from the Pilot Track Detail Panel of FIG. 4;

FIG. 6 is an expanded view in isolation of a Speed Panel from the Pilot Track Detail Panel of FIG. 4;

FIG. 7 is an expanded view in isolation of a Level Panel from the Pilot Track Detail Panel of FIG. 4;

FIG. 8 is an expanded view in isolation of a Main Control Panel from the Pilot Track Detail Panel of FIG. 4;

FIG. 9 is an expanded view in isolation of a Heading Panel of the Main Control Panel of FIG. 8;

FIG. 10 is an expanded view in isolation of a ROC/ROD Panel of the Main Control Panel of FIG. 8;

FIG. 11 is an expanded view in isolation of an Emergency SSR Code Panel of the Main Control Panel of FIG. 8;

FIG. 12 is an expanded view in isolation of a Take-Off Time Panel of the Main Control Panel of FIG. 8;

FIG. 13 is an expanded view in isolation of an Action Panel from the Pilot Track Detail Panel of FIG. 4;

FIG. 14 is a system block diagram illustrating a portable electronic device to provide information about an aircraft and to control an aircraft in a currently executing training exercise in an ATC system;

FIG. 15 is a block diagram illustrating connection states of the portable electronic device of FIG. 14;

FIG. 16 is a flow diagram illustrating a process of managing a connection of the portable computer tablet device of FIG. 14;

FIG. 17 is a flow diagram illustrating a process of controlling a simulated aircraft in a training exercise using the portable computer tablet device of FIG. 14;

FIG. 18 is a flow diagram illustrating a process of updating an active track of a simulated aircraft in a training exercise using the portable computer tablet device of FIG. 14;

FIG. 19 is a flow diagram illustrating a process of processing operator input using the portable computer tablet device of FIG. 14; and

FIG. 20 is a block diagram of a portable electronic device, such as a tablet computing device, to provide information about an aircraft and to control an aircraft in a currently executing training exercise in an ATC system.

### DETAILED DESCRIPTION

Methods using portable handheld devices, such devices themselves adapted for controlling a simulated aircraft in a currently executing training exercise in an ATC system, and computer program products for the same are disclosed. In the following description, numerous specific details, including particular electronic portable devices, computer system configurations, wireless communications protocols, and the like are set forth. However, from this disclosure, it will be apparent to those skilled in the art that modifications and/or substitutions may be made without departing from the scope and spirit of the invention. In other circumstances, specific details may be omitted so as not to obscure the invention.

Where reference is made in any one or more of the accompanying drawings to steps and/or features, which have the same reference numerals, those steps and/or features have for the purposes of this description the same function(s) or operation(s), unless the contrary intention appears.

### Overview

The embodiments of the invention provide an ATC Training Instructor with a portable electronic device (preferably, a computer tablet device) that connects wirelessly to the ATC Training System and offers information and control of aircraft in the currently executing exercise. The embodiments of the invention allow the ATC Training Instructor to have direct control of aircraft in the training exercise, as well as having detailed information on the active aircraft being controlled. This control capability and information is such that the instructor can carry it with the instructor and access the control capability and the information regardless of the instructor's location (i.e. in training room, standing adjacent to trainee, in control room, etc).

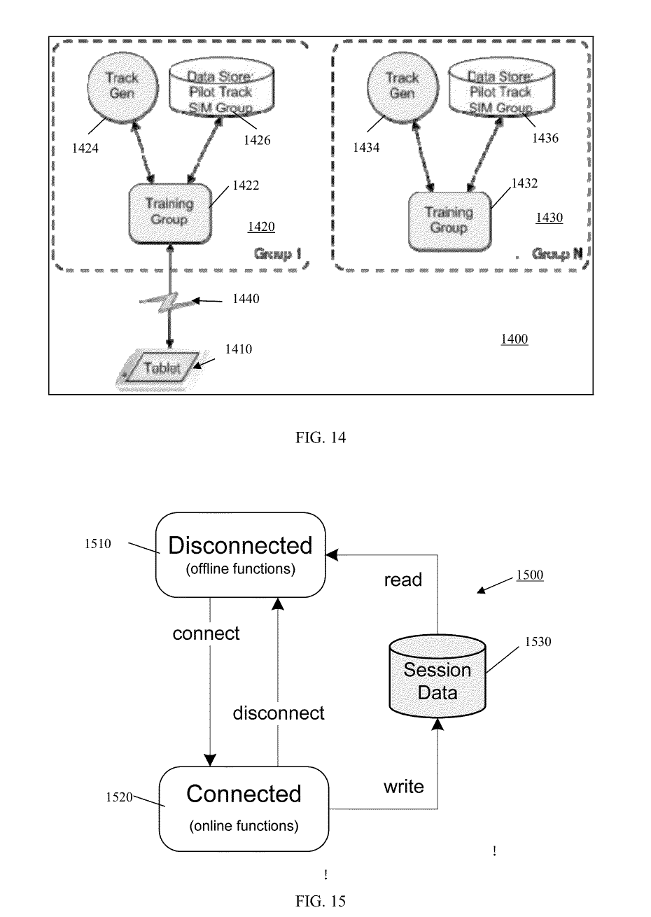

FIG. 14 illustrates a portable electronic device 1410, preferably a portable tablet computing device, to provide an ATC Training Instructor with control of a simulated aircraft in an exercise running on an ATC system 800 having a simulator. The portable computer tablet device 1410 can either be disconnected, or connected using wireless communications 1440 (e.g., IEEE 802.11B/G/N) to one or more ATC simulation groups 1420,1430. The system 1400 may have 1 to N simulation groups 1420, 1430, where N is an integer. Each simulation group 1420, 1430 comprises a training group 1422,14, which can communicate with the controller tablet 1410. In turn, the training group 1422, 1432 is coupled to a track generator 1424, 1434, which simulates the behaviour of all of the aircraft in the training exercise, and a data store 1426, 1436 having pilot track SIM group 1426, 1436, which stores the status information about the current exercise being executed and information about each aircraft (pilot track) in the exercise, such as current state and planned behaviour. These components and their operation are described in greater detail hereinafter.

The portable electronic device for controlling a simulated aircraft in a training exercise executing in an Air Traffic Control (ATC) system having a simulator comprises a wireless communications interface, a display, a memory, a user input mechanism for receiving user inputs, and a processor. The wireless communications interface is adapted for wirelessly communicating with the simulator also suitably adapted for wireless communications. The memory stores data and one or more computer programs. The processor is coupled to the memory, the user input mechanism, the display, and the wireless communications interface. The processor executes computer program code for displaying on the display information about an aircraft in a training exercise executing on the simulator and for receiving inputs to control the aircraft in the training exercise on the simulator. The displayed information and the received inputs are communicated between the simulator and the portable electronic device. Preferably, the portable electronic device is implemented in a tablet computing device, where the display and the user input mechanism are implemented using a touchscreen. The computer program executing on the processor may provide an Aircraft Control Display displayed on the display. The portable electronic device may further comprise computer program code executing on the processor to provide graphical objects displayed on the display for controlling operation of an aircraft in the training exercise on the simulator in response to a user input received by the user input mechanism. The portable electronic device may further comprise computer program code executing on the processor to provide a graphical object for displaying and adjusting operating parameters of the aircraft in the training exercise that are carried out on the simulator.

The portable tool 1410 in accordance with the embodiments of the invention allows an ATC Training Instructor to connect wirelessly to the ATC Training System and view the active aircraft in the currently executing training exercise and provide the ability to control these aircraft through various interactions with the tool 1410. This aircraft control includes:
Altitude or flight level,
Speed,
Heading,
Rate of climb (ROC) or rate of descent (ROD) for an altitude change,
Take off time, and
Aircraft transponder code (SSR code).

The use of such a portable tablet computing device provides an Air Traffic Control Training Instructor with direct control of a simulated aircraft in an ATC training exercise that is being executed by an ATC Training System and timely information. For example, the embodiments of the invention may be implemented using an Apple iPad™ or a similar handheld wireless computing device capable of displaying information and receiving user inputs that can be transmitted to the ATC training simulator. An Android tablet or a Blackberry Playbook™ are examples of other portable electronic devices that may be programmed, e.g. with a controller app, that can be used to practice the invention. The timely information includes the status of the aircraft, including but not limited to, altitude, speed, heading, take off time and aircraft transponder code, the use of a portable tablet computing device is proposed by this invention.

The use of such a portable device to control simulated aircraft within training exercises is expected to provide significant efficiency gains and resolve a number of issues related to exercise control that are caused by the configuration and physical layouts of some ATC training systems.

The portable device utilizes a display to allow the training instructor to visualize the list of active simulated aircraft in a currently executing ATC training exercise and accepts direct interaction though touch (i.e. taps, swipes, gestures, etc.) to allow the training instructor to select one of the active aircraft and change the state of this aircraft.

### Air Traffic Control Systems and Training Systems

As used herein, Air traffic control (ATC) is a service provided by ground-based controllers who direct aircraft on the ground and in the air. Such Air Traffic Controllers utilise Air Traffic Control Systems to perform this activity, with the primary objectives being to:
Separate aircraft to prevent collision;
Expedite the flow of aircraft through the airspace that the Controllers are managing to minimise delays; and
Provide information and support to pilots as required.

Air Traffic Control systems receive data from multiple sources. This source data may include:
Flight plan information: this provides, as a minimum, details of an aircraft's identification (callsign), the type of aircraft, performance characteristics including equipment on board, arrival and destination airports, estimated time of departure and planned route to fly.
Surveillance data: this is traditionally provided by radars. However, more recently other systems such as ADS-B and Multi-lateration have been developed to also provide this information. The data usually includes an aircraft identifier, which could be callsign, a transponder code or other unique code, aircraft position, altitude, speed and heading.
Weather information: this could consist of wind direction and speed along with temperature at various levels and locations or radar data that shows areas of rain.

The Air Traffic Control system, when processing the source data, performs the following actions:
Association of received surveillance data with known flight plan information.
Predicting and highlighting any dangerous conditions, which can include a breakdown in separation (i.e. aircraft flying too close), aircraft entering restricted areas or aircraft flying too low.
Monitoring flights for conformance, which can include detecting if aircraft has deviated from the planned route defined in its associated flight plan, determining if aircraft is flying at an unauthorised altitude or if aircraft is late in reporting in.

An Air Traffic Controller has access to all of the above information through a graphical user interface. Traditionally, this is through an air situation display that offers a two-dimensional representation of the airspace that the air traffic controller is managing. Maps of the airspace being managed are overlayed with symbols representing the location of specific aircraft within this airspace. The air traffic controller can access information about the aircraft the air traffic controller is managing through separate windows that may be opened on the screen, over the air situation display, or through a data block, or tag, that is attached to the aircraft symbol.

Proper training of Air Traffic Controllers is critical. The systems that the controllers are using can be quite complex and the procedures rules and regulations that need to be followed are also complex. The initial training of an air traffic controller takes several years, with additional yearly training required throughout the rest of their career. In addition to training on all of the procedures and regulations, a trainee controller is also required to be trained on the use of the air traffic control system. This is done on an air traffic control training system.

An ATC training system is usually an air traffic control system that is identical to that used by the organisation training the controller to manage real aircraft, however instead of being connected to live external interfaces for flight plan and surveillance data the ATC system is connected to a simulator. The ATC simulator provides all of the data required for an ATC system to operate as the ATC system would normally (i.e. flight plans, radar feeds, weather information, etc.). Specific training scenarios are managed through training exercises. These training exercises specify the environment for a planned training scenario and define the aircraft that operate in this environment. Each aircraft in the exercise is scripted as to when the aircraft departs, the route the aircraft will fly and any interaction that is planned with the ATC system (i.e. reporting, transponder codes, etc.). ATC training instructors are able to create different exercises, with different scenarios, to provide training on specific actions, events or procedures to a trainee.

The operation of an ATC Training system is usually managed through a dedicated computer position. This management position allows the training supervisor to select a training exercise for execution, allocate the physical ATC controller positions for use during this exercise and control the operation of this exercise. This exercise control includes, as a minimum, starting the exercise, pausing the exercise to possibly discuss events with the trainee and setting the exercise execution speed. An exercise may need to operate at a faster speed than normal to get to a point in the exercise where a specific scenario is to occur, or may need to operate at a slower speed than normal to give a trainee time to respond and adequately cope with a particularly difficult scenario.

In addition to the exercise manager position a number of other positions are also included in an ATC Training system to allow for manual control of the simulated aircraft in the training exercises. These positions, sometimes referred to as Pilot Positions, allow an operator to act as a pilot for one or more aircraft in an executing training exercise. These “pilots” respond to clearances and commands given to them by the trainee air traffic controllers via a voice communications system that is similar to the operational system and, using the tools provided on the pilot position, direct the simulated aircraft to respond according to those clearances.

For simple training exercises a training instructor would normally allocate one to two pilot positions per ATC trainee. However for more complex exercises where a controller needs to be trained on high traffic density environments or specific events requiring significant manual control of aircraft, as many as five pilots per ATC trainee may need to be allocated. This makes the training air traffic controllers, not only a complex and time consuming activity, but also an extremely labour and resource intensive activity. A tool in accordance with an embodiment of the invention would improve the efficiency of ATC training.

### Portable Device

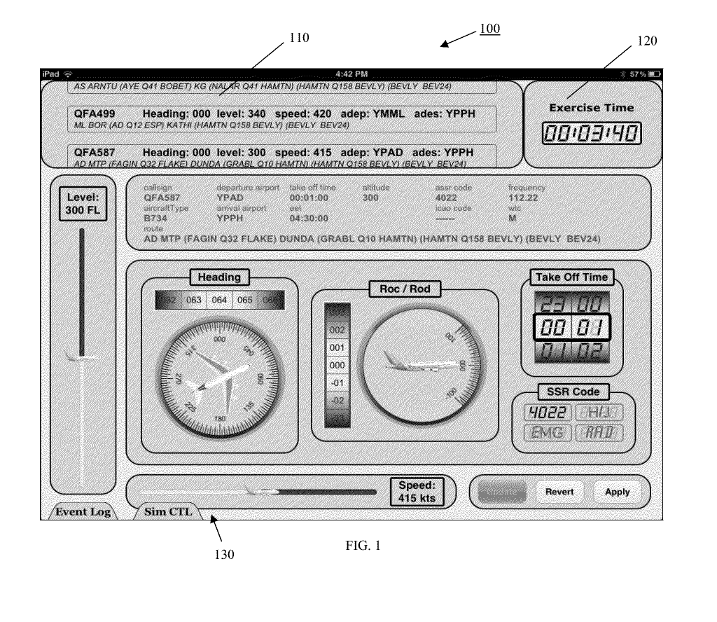

The portable device connects to an ATC Training System via a wireless network connection and interchanges data and control messages with this system. The training supervisor is able to view and interact with this through an Aircraft Control Display 100 as shown in FIG. 1 provided on the portable device 1410.

The Pilot Control screen 100 is used to display and modify the individual aircraft that are active in the currently executing training exercise. The screen is split into three main sections 110, 120, 130, with the third section 130 being split into further components. At the top left is the Active Pilot Track panel 110, to the right of this is the Exercise Time Panel 120 and below these two panels is the Pilot Track Detail panel 130.

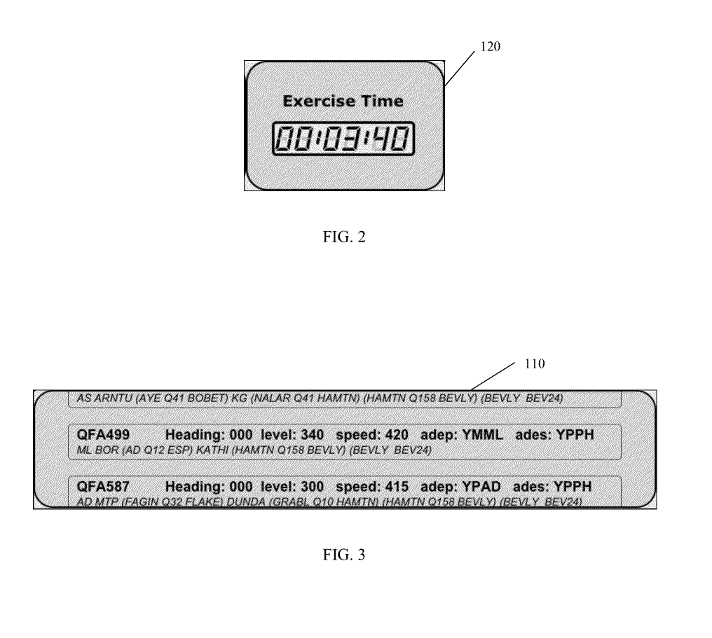

The Exercise Time panel 120 shown in isolation in FIG. 2 displays the time within the currently executing training exercise. The Active Pilot Track pane 110 shown in isolation in FIG. 3 is a panel that displays all currently active aircraft tracks in the currently executing training exercise. Each aircraft in this list is selectable controllable. These aircraft are displayed as list items, or strips, and are ordered by callsign. Each strip displays the callsign, heading, level, speed, departure airport, destination airport and planned route of an aircraft.

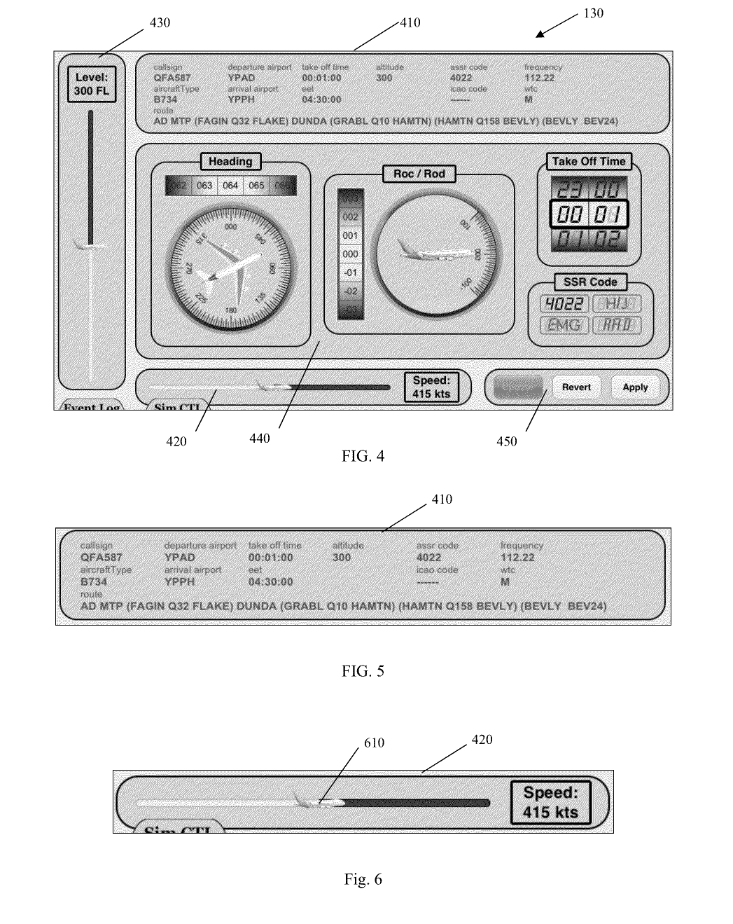

To display more than the first two strips in FIG. 1 the user presses their finger on the screen and swipes up towards the top of the screen. This will result in the strips scrolling up the screen (from bottom to top) to reveal more strips below. The user can also swipe down to scroll back to the top of the list. The user may select an aircraft in the list by tapping on the strip, which is then be displayed in the Pilot Track Detail panel 130 shown in isolation in FIG. 4.

The Pilot Track Detail panel 130 in FIG. 4 displays detailed information about the selected aircraft and its associated flight plan. Some of this information is for display only, but some information may be modified. This includes: level or altitude, speed, heading, rate of climb or descent, take-off time, and aircraft transponder (SSR) code. SSR is secondary surveillance radar. The Pilot Track detail panel 130 comprises a Track Information panel 410, a Speed panel 420, a Level panel 430, a Main Control panel 440, and an Action panel 450.

The Track Information panel 410 shown in isolation in FIG. 5 is for display purposes only and displays the selected aircraft's associated flight information such as departure airport, destination airport, assigned transponder code, radio frequency, and wake turbulence category.

The Flight Speed panel 420 shown in isolation in FIG. 6 allows the user to modify the speed of the selected aircraft using the graphical display of the portable electronic device 1410. This is managed by the operator pressing their finger on the image of the aircraft 610 in the panel and dragging the aircraft 610 to the left or right to change the speed value. Removing the finger causes the portable electronic device 1410 to save the current selected speed value. For example, in FIG. 6, the current speed is set at 415 knots.

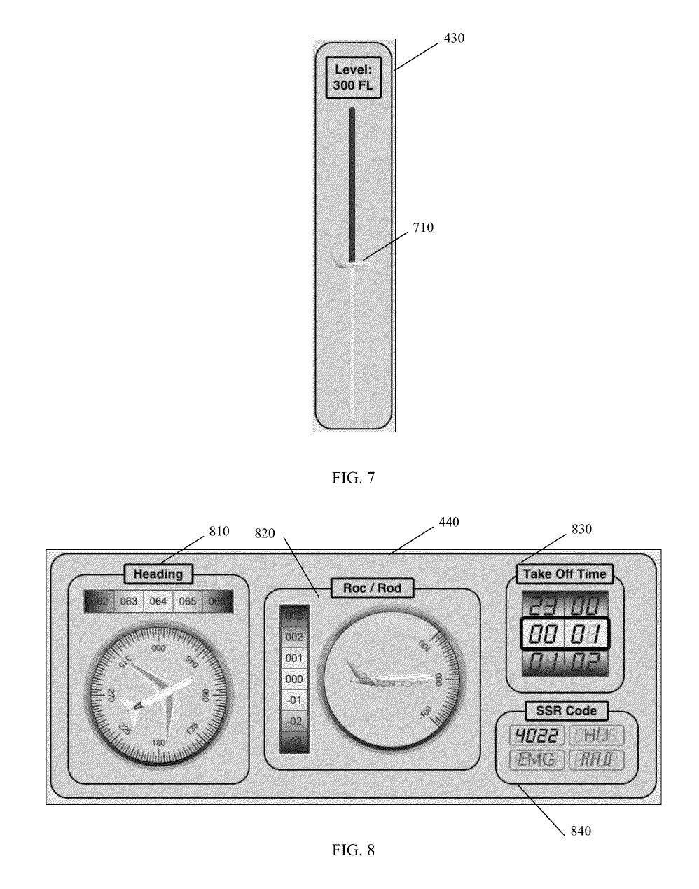

The Flight Level panel 430 shown in isolation in FIG. 7 allows the user to adjust the level of the flight by dragging the aircraft graphical object/icon 710 up or down to the change the level value in a similar method to that used in the speed panel. For example, in FIG. 7, the current level is set at flight level 300 (FL). The value flight level 300 (FL) in FIG. 1 indicates that the aircraft is at an altitude of 30,000 feet in units of 100 feet.

The Main Control panel 440 shown in isolation in FIG. 8 allows the user to modify four main components of the selected aircrafts state: a Heading (direction of flight) panel 810, a rate of climb or descent (Roc/Rod) panel 820, a Take-Off Time panel 830, and an Emergency SSR Code indicators panel 840. If any of these values are modified; the border around the effected panel indicates that a change has been made.

As shown in FIG. 9, the user may modify using the Heading Panel 410 the heading of the selected aircraft using two different methods. The first method is for the user to select the aircraft 930 within the displayed Heading gauge 920 using their finger and drag the aircraft 930 around in a circular motion. For heading, the aircraft can move in the full 360 degree range to select a new heading value. The heading will be set to the value that the aircraft 930 in the panel is pointing to, e.g. 064 in FIG. 9. As the aircraft 930 is moved within the Heading Gauge 920 the associated Accurate Picker 910 is also updated to reflect the value. When using the gauge method, the values selected are not always accurate enough but the heading can be adjusted by large amounts quite easily and quickly. The user can then adjust in small increments using the Accurate Picker 910 to fine tune the value that is desired. This is achieved by the user pressing their finger on the Accurate Picker 910 and dragging the Accurate Picker 910 in the direction the aircraft 930 is to rotate in. Lifting the operator's finger from the screen stops the Picker 930 rotating.

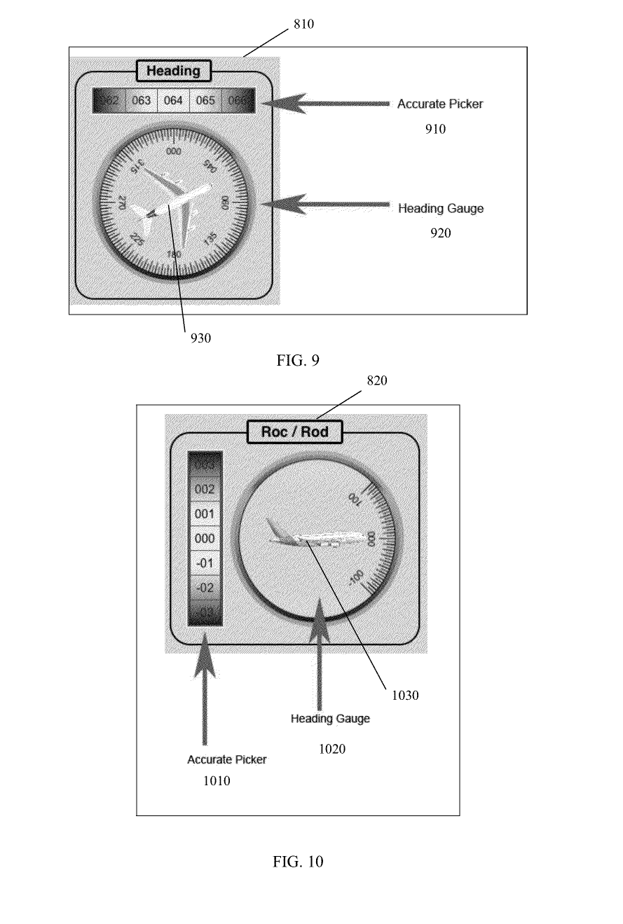

As shown in FIG. 10, the user may modify using the Roc/Rod Panel 820 the rate of climb or descent (ROC/ROD) of the selected aircraft using two different methods. For ROC/ROD, the aircraft 1030 has a 90 degree range in which the aircraft 1030 can move to select a new ROC/ROD value. As for the heading, the rate of climb or descent is set to the value that the aircraft in the panel is pointing to in the Heading Gauge 1020. A positive value (aircraft 1030 pointing up) indicates a rate of climb, and a negative value (aircraft 1030 pointing down) indicates a rate of descent. As the aircraft 1030 is moved within the Heading Gauge 1020 the associated Accurate Picker 1010 is also updated to reflect the value. When using the gauge method, the values selected are not always accurate enough but the ROC/ROD can be adjusted by large amounts quite easily and quickly. The user can then adjust in small increments using the Accurate Picker 1010 to fine tune the value that is desired. This is achieved by the user pressing their finger on the Accurate Picker 1010 and dragging the Accurate Picker 1010 in the direction the aircraft 1030 is to rotate in (climb/descend). Lifting the operator's finger from the screen stops the Picker 1030 rotating.

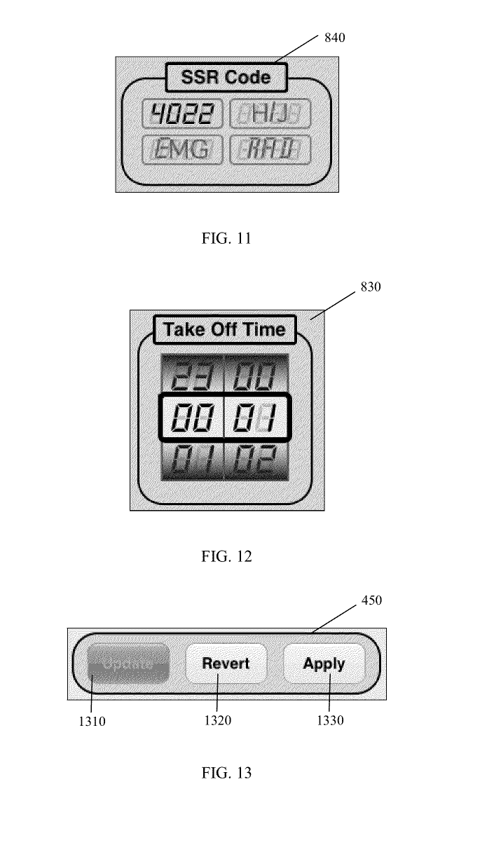

The Emergency SSR Code panel 840 shown in isolation in FIG. 11 allows the user to modify the transponder code of the selected aircraft to an emergency code or back to the aircraft's original assigned code. There are four values that can be selected: the original SSR code and three emergency states. The emergency states are: HIJack, RADio failure, and general EMerGency. The value is selected by the user tapping their finger on the desired code. The selected code is highlighted, e.g. 4022 in FIG. 11. Only one value may be selected at a time. The SSR code is unique (e.g. 4022) to identify the aircraft and is assigned by the ATC Training System when the training exercise is being created.

The Take-Off Time Panel 830 shown in isolation in FIG. 12 allows the user to adjust the take-off time of the selected aircraft. This is achieved by the user pressing their finger on the hours or minute value and swiping the user's finger up or down to scroll though the various values for hour and minute. In the hour column, the user can select within the range of 00 to 23. In the minute column, the user can select in the range 00 to 59.

The Action Panel 450 shown in isolation in FIG. 13 is where the changes made within the interactive panels can be confirmed and then sent to the ATC Training System. By tapping the operator's finger on the desired action, the user can select: Update, Revert or Apply. The Update button 1310 (graphical object) is either greyed out and not selectable or highlighted and selectable. If this button 1310 is highlighted, this indicates that the currently selected aircraft has been updated externally by the ATC Training System and the displayed information is now out of date. Selecting this button 1310 by tapping on the button 1310 discards any changes the user has made but has not applied and updates the selected aircraft's information with any new information that has been provided by the ATC Training System. The Revert button 1320 discards any changes the operator has made but has not applied to the selected aircraft and displays the information that was present before the operator started to make any changes. The Apply button 1330 takes any changes the operator has made and sends the changes to the ATC Training System to update the selected aircraft. The Apply button can be pressed at any time. If any of the above buttons are selected and the various modifiable components have a highlighted border indication, these border highlights are then removed.

### Processing on Portable Device

A number of processes utilised by a portable device in accordance with an embodiment of the invention are described hereinafter in greater detail. The processes enable the portable device to control the aircraft operating within a training exercise in an Air Traffic Control (ATC) training system and to control behaviour of the simulated aircraft in the training system. The portable tablet device connects wirelessly to an ATC simulation group in the training system. The portable tablet device provides tactical tools to assist the execution of the exercise and evaluation of the student.

As shown in FIG. 14, the portable tablet device 1410 can be connected to, or disconnected from, any one of N ATC simulation groups. In the example shown in FIG. 14, the tablet device 1410 is wirelessly connected to the simulation group 1410 and is disconnected from the simulation group 1420. FIG. 15 illustrates the states and overall operation of the portable tablet device 1010 to control operation of the simulated aircraft in a training exercise. The portable tablet device may be in a disconnected 1510 or connected 1520 state or mode and can transition from either mode to the other relative to a simulation group. So, from the disconnected mode 1510, the portable tablet device may connect to a simulation group and enter the connected state or mode 1520. Likewise, from the connected mode 1520, the portable tablet device may disconnect from a simulation group and enter the disconnected mode 1510. In the connected mode 1520, session data 1530 may be written to a storage device of the portable tablet device. In the disconnected mode 1510, the session data 1530 may be read by the portable tablet device. In the disconnected state 1510, the device 1410 provides offline functions, e.g. access to the data 1530 from previous sessions. In the connected state 1520, the device 1410 provides online functions, e.g. control simulated aircraft within the current training exercise.

The data exchange between the portable device 1410 of FIG. 14 and the simulation group 1410, 1420 follows the client/server pattern. The device (client) 1410 connects to the simulation group (server) 1420, 1430 on demand. Only one device 1410 may be connected to a simulation group 1420, 1430 at any given time.

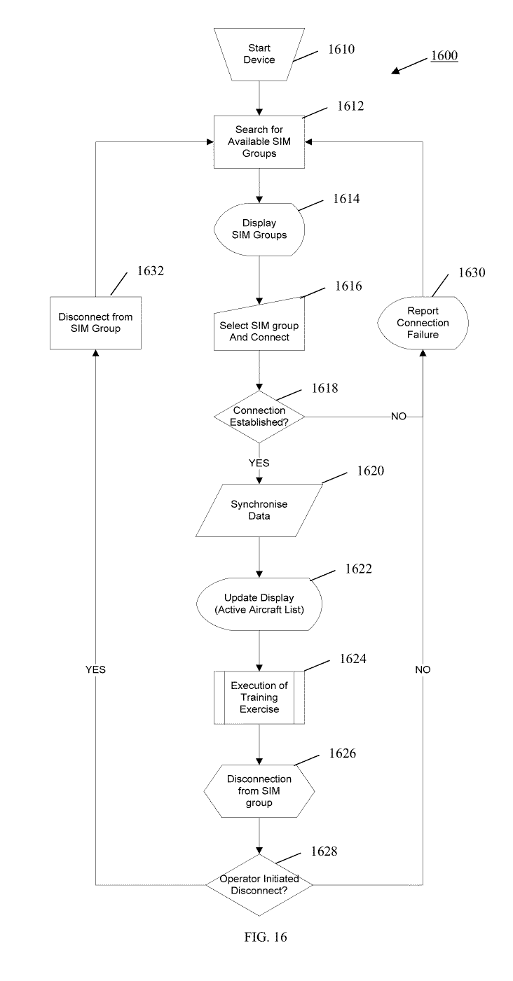

FIG. 16 illustrates a connection management process 1600. In step 1610, the portable tablet device 1410 is started. In step 1612, a search is performed by the device 1410 for available SIM (simulation) groups 1420, 1430. In step 1614, any simulation groups that were found in the search are displayed on the device 1410. In step 1616, an operator (e.g., an instructor) can select a SIM group and wirelessly connect to the SIM group. The operator may provide inputs to the tablet to do this. In decision step 1618, a check is made by the device to determine if a connection was established. If step 1618 returns false (NO), processing continues at step 1630. In step 1630, the device 1410 reports a connection failure and processing continues at step 1612 to search for available SIM groups. Otherwise, if decision step 1618 returns true (YES), processing continues at step 1620.

In step 1620, data is synchronised between the device 1410 and the data store 1426, 1436 of the connected SIM group. This may be done by wireless communications transmitting data regarding the training exercise to the tablet device 1410 from the simulator, and vice versa. In step 1622, the display (including Active Aircraft List) on the device 1410 is updated. For example, the Aircraft Control Display 100 of FIG. 1 is updated. In step 1624, the training exercise is executed and the device 1410 remains in the connected state. At some point, disconnection from the connected SIM group occurs in step 1626. The device is now in the disconnected state. The portable device 1410 performs a decision step 1628 in which a check is made of whether the operator initiated the disconnect. If decision step 1628 returns false (NO), processing continues at step 1630. Otherwise, if decision step 1628 returns true (YES), processing continues at step 1632. In step 1632, the portable device disconnects from the SIM group. Processing then continues at step 1612.

Aircraft are controlled through the exchange of messages between the portable device 1410 and the attached simulation group 1420, 1430. This aircraft control includes:
Altitude or flight level,
Speed,
Heading,
Rate of climb (ROC) or rate of descent (ROD) for an altitude change,
Take off time, and
transponder code (SSR code).

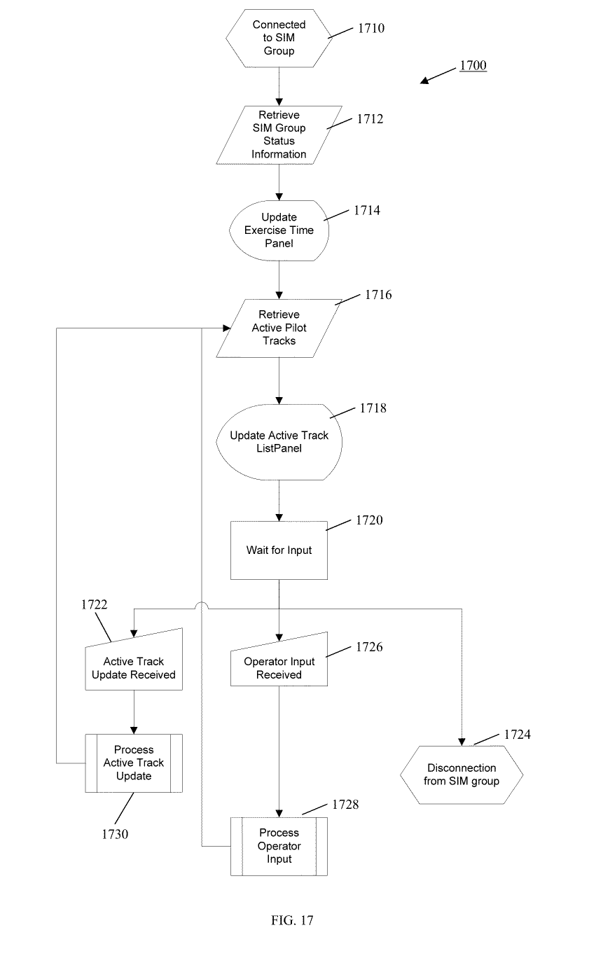

FIG. 17 illustrates a process 1700 of controlling a simulated aircraft in a training exercise using the device 1410 through the exchange of messages (e.g., using wireless communications) between the portable device 1410 and the attached simulation group 1420, 1430 in FIG. 14. In step 1710, the portable device 1410 is connected to a SIM group 1420, 1430. In step 1712, the device 1410 retrieves status information of the SIM group from the data store 1426, 1436. In step 1714, the Exercise Time Panel is updated and displayed on the portable device 1410. In step 1716, the Active Pilot Tracks are retrieved from the simulator. In step 1718, the Active Track List Panel is updated on the portable device 1420. In step 1720, the device 1410 then enters a state of waiting for an input of the operator using the input mechanism (e.g., the touchscreen of a tablet device), or an update received from the ATC Training System. From step 1720 processing can continue at any one of steps 1722, 1724, and 1726.

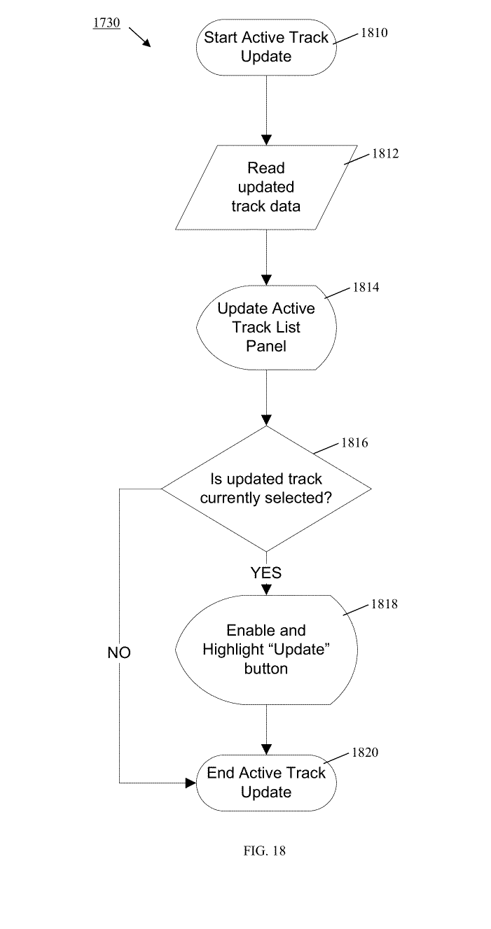

In step 1722, the device 1410 receives an Active Track Update from the training system/simulator. In step 1730, the Active Track Update is processed by the device 1410, as described in detail hereinafter with reference to FIG. 18, and processing continues at step 1716.

In step 1724 from step 1720, the portable device 1724 enters a disconnection state from the SIM group.

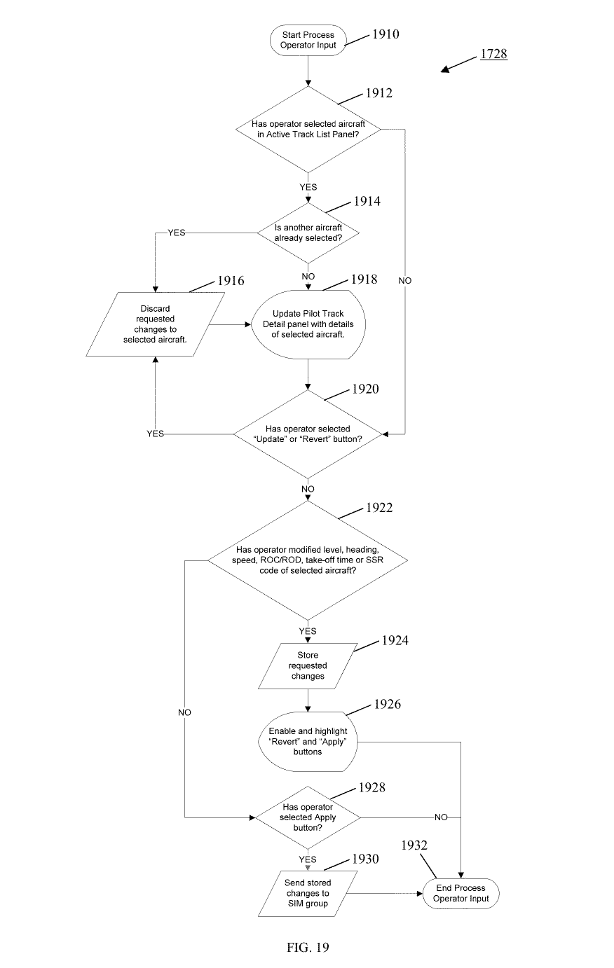

In step 1726, an operator input is received by the device 1410. In step 1728, the operator input is processed, as explained with reference to FIG. 19 hereinafter. Processing then continues at step 1716.

FIG. 18 illustrates in detail a process 1730 of processing an Active Track Update. In step 1810, the Active Track Update is started. In step 1812, the portable device reads the updated track data. In step 1814, the Active Track List Panel is updated and displayed by the portable device 1420. In decision step 1816, a check is made to determine if the update track is currently selected. If decision step 1816 returns false (NO), processing continues at step 1820 and the Active Track Update ends. Otherwise, if decision step 1816 returns true (YES), processing continues at step 1818. In step 1818, the portable device 1410 enables and highlights the “Update” button. In step 1820, the Active Track update ends.

FIG. 18 is a detailed flow diagram illustrating the process 1728 of processing operator inputs. In step 1910, the processing of operator input starts. In decision step 1912, a check is made to determine if the operator has selected an aircraft in the Active Track List panel. If decision step 1912 returns false (NO), processing continues at step 1920. Otherwise, if decision step 1912 returns true (YES), processing continues at step 1914. In decision step 1914, a check is made to determine if another aircraft is already selected. If decision step 1914 returns false (NO), processing continues at step 1918. In step 1918, the Pilot Track Detail panel is updated with details of the selected aircraft. Processing then continues at step 1920. Otherwise, if step 1914 returns true (YES), processing continues at step 1916. In step 1916, the requested changes to the selected aircraft are discarded. Processing continues at step 1918. In decision step 1920, a check is made to determine if the operator has selected the “Update” or “Revert” button displayed on the portable device 1420. If decision step 1920 returns true (YES), processing continues at step 1916. Otherwise, if decision step 1920 returns false (NO), processing continues at step 1922.

In decision step 1920, a check is made to determine if the operator has modified level, heading, speed, ROC/ROD, take-off time, or SSR code of the selected aircraft. If decision step 1922 returns false (NO), processing continues at step 1928. Otherwise, if decision step 1922 returns true (YES), processing continues at step 1924 and the requested changes are stored. In step 1926, the “Revert” and “Apply” buttons are enabled and highlighted. Processing continues at step 1932 and the processing of operator input ends.

In decision step 1928, a check is made to determine if the operator has selected the “Apply” button. If decision step 1928 returns false (NO), processing continues at step 1932. Otherwise, if decision step returns true (YES), processing continues at step 1930. In step 1930, stored changes are sent to the SIM group. Processing continues at step 1932 and the processing of operator input ends.

### Portable Electronic Device Capable of Wireless Communications

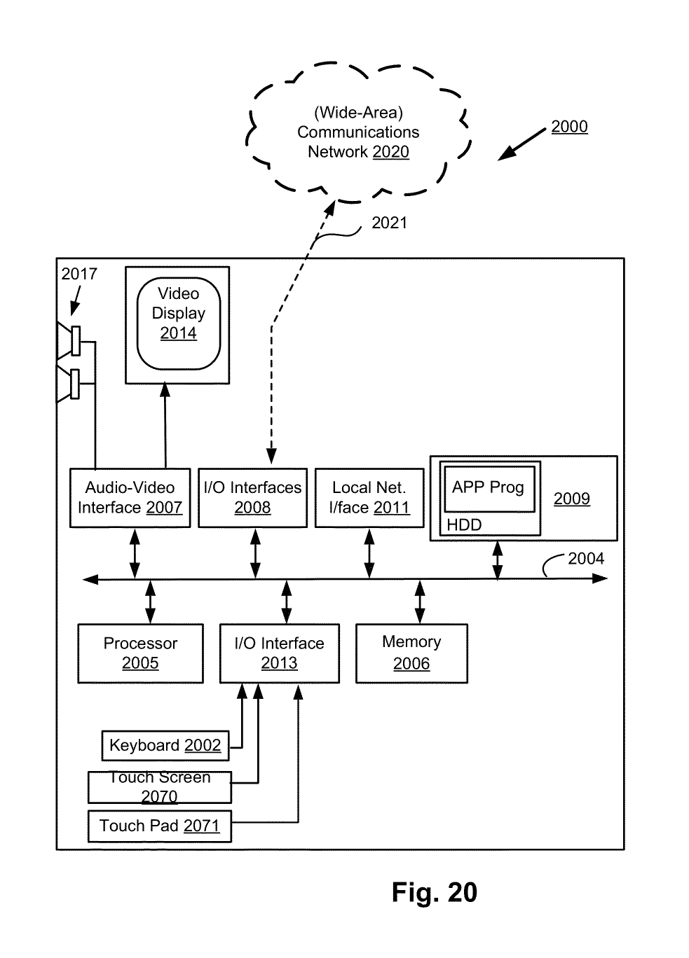

FIG. 20 is a block diagram of handheld portable electronic device 2000, such as a tablet computing device like the Apple™ iPad™, with which embodiments of the invention may be practiced.

As seen in FIG. 20, the device 2000 includes: a processor 2005, input devices (such as a keyboard 2002, a touchscreen 2070, and a touchpad 2071), output devices (such as a display device 2014 and audio/video output; speakers 2017 are optional). A wireless interface 2008, such as WiFi, allows wirelessly communicating 2021 to and from a communications network 2020. The communications network 2020 may be a wide-area network (WAN), such as the Internet, a cellular telecommunications network, or a private WAN.

Preferably, the video display 2014, a touchscreen 2070, processor 2005, etc are all contained in the same physical container or housing, e.g. as would the case of a tablet computing device. The processor 2005 is coupled to a memory unit 2006, which may be semiconductor random access memory (RAM) and semiconductor read only memory (ROM). An audio-video interface 2007 couples the other device components to the video display 2014, and optional speakers 2017. An I/O interface 113 can be coupled to the keyboard 2002, the touchscreen 2070, and touchpad 2071, and optionally any other human interface device (not illustrated). The device 2000 may have a local network interface 2011, which permits coupling of another communications network, such as a Local Area Network (LAN). The local network interface 2011 may comprise an Ethernet™ circuit card or a Bluetooth™ wireless arrangement; however, numerous other types of interfaces may be practiced for the interface 2011.

The I/O interfaces 2008 and 2013 may afford either or both of serial and parallel connectivity, the former typically being implemented according to the Universal Serial Bus (USB) standards and having corresponding USB connectors (not illustrated). Storage devices 2009 are provided and typically include a hard disk drive (HDD). Other storage devices may also be used. Portable memory devices, such optical disks (e.g., CD-ROM, DVD, Blu ray Disc™), USB-RAM, portable, external hard drives, and floppy disks, for example, may be used as appropriate sources of data to the system 2000.

The components 2005 to 2013 of the device 2000 typically communicate via an interconnected bus 2004 and in a manner that results in a conventional mode of operation of the computer system 2000 known to those in the relevant art. For example, the processor 2005 is coupled to the system bus 2004. Likewise, the memory 2006 is coupled to the system bus 2004.

The method using portable handheld devices for controlling a simulated aircraft in a currently executing training exercise in an ATC system may be implemented as one or more software application programs executable on the processor 2005. In particular, the steps of the method may be effected by instructions in the software that are carried out within the device 2000. The software instructions may be formed as one or more computer program code modules, each for performing one or more particular tasks. The software may also be divided into two separate parts, in which a first part and the corresponding code modules performs the image arranging methods and a second part and the corresponding code modules manage a user interface between the first part and the user.

The software may be stored in a computer readable medium. The software is loaded into the processor from the computer readable medium, and then executed. A computer readable medium having such software or computer program recorded on the computer readable medium is a computer program product. The use of the computer program product in the device preferably effects an advantageous apparatus for controlling a simulated aircraft in a currently executing training exercise in an ATC system.

In some instances, the application programs may be supplied to the user encoded on one or more CD-ROMs and read via a corresponding drive, or alternatively may be read by the user from the network 2020. Still further, the software can also be loaded into the device 2000 from other computer readable media. Computer readable storage media refers to any storage medium that provides recorded instructions and/or data.

The second part of the application programs and the corresponding code modules mentioned above may be executed to implement one or more graphical user interfaces (GUIs) to be rendered or otherwise represented upon the display 2014. The display 2014 is preferably comprised of a touchscreen 2070, where a finger may be used to manipulate the interface to provide controlling commands and/or input to the software applications associated with the GUI(s). In this instance, the device 2000 may not require the keyboard 2002.

The arrangements described are applicable to the ATC systems and in particular training systems for such ATC systems.

Methods using portable handheld devices and such devices themselves adapted controlling a simulated aircraft in a currently executing training exercise in an ATC system have been described. The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. An open ended meaning is contemplated, instead of a close-ended expression such as “consisting of”. Variations of the word “comprising”, such as “comprise” and “comprises” have correspondingly varied meanings.

1. A portable electronic device for controlling a simulated aircraft in a training exercise executing in an Air Traffic Control (ATC) system having a simulator, said device comprising:
a wireless communications interface for wirelessly communicating with said simulator adapted for wireless communications;
a display;
a memory for storing data and one or more computer programs;
a user input mechanism for receiving inputs;
a processor coupled to said memory, said user input mechanism, said display, and said wireless communications interface, said processor executing computer program code for displaying on said display information about an aircraft in a training exercise executing on said simulator and for receiving inputs to control said aircraft in said training exercise on said simulator, said displayed information and said received inputs being communicated between said simulator and said portable electronic device.

2. The portable electronic device as claimed in claim 1, being implemented in a tablet computing device, wherein said display and said user input mechanism are implemented using a touchscreen.

3. The portable electronic device as claimed in claim 1, wherein said computer program executing on said processor provides an Aircraft Control Display displayed on said display.

4. The portable electronic device as claimed in claim 1, further comprising computer program code executing on said processor to provide graphical objects displayed on said display for controlling operation of an aircraft in said training exercise on said simulator in response to a user input received by the user input mechanism.

5. The portable electronic device as claimed in claim 1, further comprising computer program code executing on said processor to provide a graphical object for displaying and adjusting operating parameters of said aircraft in said training exercise that are carried out on said simulator.

6. The portable electronic device as claimed in claim 1, further comprising computer program code executing on said processor to control a simulated aircraft, the aircraft control comprising:
Altitude or flight level,
Speed,
Heading,
Rate of climb (ROC) or rate of descent (ROD) for an altitude
change,
Take off time, and
Aircraft transponder code (SSR code).

7. A method of controlling a simulated aircraft in a training exercise executing in an Air Traffic Control (ATC) system having a simulator, said method comprising:
displaying on a display of said portable electronic device information about an aircraft in said training exercise executing on said simulator;
receiving inputs using said portable electronic device to control said aircraft in said training exercise executing on said simulator; and
wirelessly communicating said displayed information and said received inputs between said simulator and said portable electronic device.

8. The method as claimed in claim 7, wherein said portable electronic device comprises a wireless communications interface for wirelessly communicating with said simulator adapted for wireless communications, a memory for storing data and one or more computer programs, a user input mechanism for receiving inputs, and a processor coupled to said memory, said user input mechanism, said display, and said wireless communications interface, said processor executing computer program code for displaying on said display information about said aircraft in said training exercise executing on said simulator and for receiving inputs to control said aircraft in said training exercise on said simulator, said displayed information and said received inputs being communicated between said simulator and said portable electronic device.

9. The method as claimed in claim 7, wherein said portable electronic device comprises a tablet computing device, wherein said display and said user input mechanism are implemented using a touchscreen.

10. The method as claimed in claim 7, comprising displaying an Aircraft Control Display on said display.

11. The method as claimed in claim 7, comprising providing graphical objects displayed on said display for controlling operation of said aircraft in said training exercise on said simulator in response to a user input received by the user input mechanism.

12. The method as claimed in claim 7, comprising providing a graphical object for displaying and adjusting one or more operating parameters of said aircraft in said training exercise carried out on said simulator.

13. The method as claimed in claim 7, further comprising providing aircraft controls using said portable electronic device to control a simulated aircraft, the aircraft control comprising:
Altitude or flight level,
Speed,
Heading,
Rate of climb (ROC) or rate of descent (ROD) for an altitude change,
Take off time, and
Aircraft transponder code (SSR code).

14. A computer program product comprising a computer readable medium having recorded thereon a computer program for controlling using a portable electronic device a simulated aircraft in a training exercise executing in an Air Traffic Control (ATC) system having a simulator, said computer program comprising:
computer program code means for displaying on a display of said portable electronic device information about an aircraft in said training exercise executing on said simulator;
computer program code means for receiving inputs using said portable electronic device to control said aircraft in said training exercise executing on said simulator; and
computer program code means for wirelessly communicating said displayed information and said received inputs between said simulator and said portable electronic device.

15. The computer program product as claimed in claim 14, wherein said portable electronic device comprises a wireless communications interface for wirelessly communicating with said simulator adapted for wireless communications, a memory for storing data and one or more computer programs, a user input mechanism for receiving inputs, and a processor coupled to said memory, said user input mechanism; said display, and said wireless communications interface, said processor executing said computer program code means for displaying on said display information about said aircraft in said training exercise executing on said simulator and computer program code means for receiving inputs to control said aircraft in said training exercise on said simulator, said displayed information and said received inputs being communicated between said simulator and said portable electronic device.

16. The computer program product as claimed in claim 14, wherein said portable electronic device comprises a tablet computing device, wherein said display and said user input mechanism are implemented using a touchscreen.

17. The computer program product as claimed in claim 14, comprising computer program code means for displaying an Aircraft Control Display on said display.

18. The computer program product as claimed in claim 14, comprising computer program code means for providing graphical objects displayed on said display for controlling operation of said aircraft in said training exercise on said simulator in response to a user input received by the user input mechanism.

19. The computer program product as claimed in claim 14, comprising computer program code means for providing a graphical object for displaying and adjusting one or more operating parameters of said aircraft in said training exercise carried out on said simulator.

20. An air traffic control (ATC) training system, comprising:
a simulator for performing a training exercise involving one or more simulated aircraft, said simulator adapted to receive from a trainee instructions for said training exercise, said simulator comprising a wireless communications interface adapted for wireless communications; and
a portable electronic device as claimed in claim 1 for controlling a simulated aircraft in said training exercise via wireless communications with said simulator.
